(19) United States
(12) Patent Application Publication
(10) Pub. No.: US 2016/0019372 A1
(43) Pub. Date: Jan. 21, 2016

(54) SYSTEMS AND METHODS FOR OBTAINING MEDIA CONSENT

(71) Applicant: Social Dental, LLC, Provo, UT (US)

(72) Inventor: Thomas Steelman Clark, Midway, UT (US)

(21) Appl. No.: 14/334,423

(22) Filed: Jul. 17, 2014

(51) Int. Cl. G06F 19/00; G06Q 50/24

(52) U.S. Cl. CPC G06F 19/363; G06Q 50/24

(57) ABSTRACT

Methods and systems are described for obtaining consent to use media. A computer-implemented method for obtaining media consent includes generating media related to at least one person, automatically prompt the at least one person to provide a digital consent to use the media, receiving the at least one person's digital consent, and delivering the digital consent to a storage location.

### BACKGROUND

Advancements in technology have made it possible for people of all ages, backgrounds, and training to easily generate media. The introduction and broad acceptance and distribution of smartphones in the past several years have placed a powerful media generating computer device in the hands of hundreds of millions of people. Smartphones and other types of fixed and mobile computing devices are capable of taking pictures, generating video content, recording sounds, generating documents and other text, as well as displaying and/or presenting this media at the computerized device itself. Furthermore, access to the Internet via wired and wireless connections makes it possible to broadcast the media almost instantaneously upon its generation.

Media generated by an individual that relates only the individual may be broadcast freely by that individual because the individual's consent to broadcast the media is implied. Reproduction of the media, in at least some settings such as on social media platforms, is often considered permissible unless otherwise stated by the individual who is included in and/or broadcasts the media. In contrast, media generated by an individual that includes other persons may have greater restrictions on the distribution of that media. Additionally, some parties who generate media that includes other individual's image, voice, etc. may be held at a higher standard to obtain consent before broadcasting the media. Such is the case in most health-related professions such as dental, chiropractic, medical, ophthalmology, and the like. The government has established regulations such as the Health Insurance Portability and Accountability Act (HIPAA) standards that protect the rights of patients and include, for example, requirements that the patient provide consent in order for the practitioner to share information associated with the patient. The information may include pictures of the patient as well as more standard information such as the patient's health history.

Opportunities exist for improving ways in which consent is obtained from patients and individuals in other settings where consent to use the media is mandatory.

### SUMMARY

Methods and systems are described for obtaining consent to use media.

In one embodiment, a computer-implemented method for obtaining media consent includes generating media related to at least one person, automatically prompting the at least one person to provide a digital consent to use the media, receiving the at least one person's digital consent, and delivering the digital consent to a storage location.

In one embodiment, the media may be at least one of a digital image, or a video clip, or an audio recording, or any combination thereof. Prompting the at least one person for digital consent may include displaying a Health Insurance Portability and Accountability Act (HIPAA) compliant form to the at least one person. Receiving the at least one person's digital consent may include receiving the at least one person's digital signature or a signature of a parent or guardian of the at least one person. The steps of generating, prompting, receiving and delivering may be conducted using a single handheld computing device. Delivering the digital consent may include emailing the digital consent. The method may include storing the digital consent in a database. Receiving the at least one person's digital consent may include receiving information including at least one of a name or address of the at least one person, and entering the information into an electronic consent form. Prompting the at least one person for digital consent may occur automatically after generating the media. Prompting the at least one person for digital consent may include prompting each of a plurality of people included in the media for digital consent. The method may include delivering the media with the digital consent to the storage location.

Another embodiment is directed to an apparatus for obtaining digital consent to use dental related media. The apparatus includes a processor, a memory in electronic communication with the processor, and instructions stored in the memory. The instructions are executable by the processor to generate media related to a dental patient, present a Health Insurance Portability and Accountability Act (HIPAA) compliant, electronic consent form to the dental patient for use of the media, receive the dental patient's digital consent on the consent form, and store the consent form.

In one example, the instructions may be executable by the processor to deliver the consent form to a remote location. Receiving the dental patient's digital consent may include receiving at least one of a full name and an electronic signature of the dental patient and a full name and signature of a parent or guardian of the patient. The apparatus may be a handheld computing device. The media may include a digital image of at least some of the dental patient's teeth.

A further embodiment is directed to a computer-program product for obtaining consent to use dental related media. The computer-program product may include a non-transitory computer-readable medium storing instructions executable by a processor to receive media related to a dental patient, display the media to the dental patient, present a Health Insurance Portability and Accountability Act (HIPAA) compliant, electronic consent form to the dental patient, receive the dental patient's consent on the consent form, and deliver the consent form to at least one destination.

In one example, delivering the consent form may include emailing the consent form, and the at least one destination comprises a dental office. Displaying the media may include displaying the media on a handheld, mobile computing device. Presenting the consent form may include displaying the consent form concurrently with or after displaying the media.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an environment in which the present systems and methods may be implemented;

FIG. 2 is a block diagram of another environment in which the present systems and methods may be implemented;

FIG. 3 is a block diagram of another environment in which the present systems and methods may be implemented;

FIG. 4 is a block diagram of another environment in which the present systems and methods may be implemented;

FIG. 5 is a block diagram of another environment in which the present systems and methods may be implemented;

FIG. 6 is a block diagram of an example consent module of the environments shown in FIGS. 1-5;

FIG. 7 is a flow diagram illustrating a method for obtaining media consent;

FIG. 8 is a flow diagram illustrating a method for obtaining digital consent to use dental related media;

FIG. 9 is a flow diagram illustrating another method for obtaining consent to use dental related media; and

FIG. 10 is a block diagram of a computer system suitable for implementing the present systems and methods of FIGS. 1-9.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods described herein relate to obtaining consent for use of media associated with one or more persons. After the media (e.g., a video clip, audio recording, picture, graphic, or text) is generated, a consent form may be automatically presented for signature by the one or more persons included in the media (e.g., a person shown in a picture or video clip) and/or who generate the media (e.g., a person's recorded voice, graphics, or written text). Once the individuals provide their written consent by filling out the consent form or otherwise indicating his/her consent, the consent form may be stored for later use. Prior to storing the consent form, the consent form may be paired or coupled with the media so that the consent form and media are stored together. The media may also be distributed or broadcast (e.g., via one or more social media platforms) after obtaining the individual's consent for use of the media.

The consent form may meet certain regulatory requirements such as, for example, the requirements of the Health Insurance Portability and Accountability Act (HIPAA) government standard. The consent form may include transfer of rights such as, for example, transfer of intellectual property rights, rights to distribution, rights of reproduction, rights to derivative works, or the sale and/or revenue associated with the media. The consent form may be crafted specifically for certain industries including, for example, the dental, medical, chiropractic, ophthalmology, or pharmaceutical industries. The consent form may be drafted specifically for other industries such as, for example, political, academic, entertainment, or the like, and may be crafted to meet requirements of international jurisdictions related to any of these industries.

The consent form may include windows or fields for filling in personal information about the individual who is intended to sign the consent form. The personal information may include, for example, full name, mailing address, telephone number, email address, familial relationships, age, citizenship, and the like. A separate consent form may be automatically presented for signature by each individual included in the media. The consent form may receive an individual's signature via, for example, a touch screen, an electronic typed signature, a check the box consent, a security or pin code, or any other of a variety of signatures or legally recognized method for showing consent.

The consent forms may be delivered to a storage location after being executed by the individual. One storage location may be memory of the device that presents the consent form or the device used to collect the individual's signature on the consent form. In another example, the signed consent form is transmitted to another location such as a front office, back end server, a cloud computing device, or the like. In one example, the signed consent form is emailed to a front office of a clinic (e.g., a dental or medical clinic) and received at a dedicated email in-box wherein the signed consent forms are stored. In another embodiment, the consent forms, along with the associated media to which the consent form is paired or linked, is stored in an electronic medical records database. In a dental setting, a patient's dental records may be stored electronically via a dental record management system such as a system available from Dentrix of American Fort, Utah. The consent form and/or the media may be transferred to and stored within the electronic dental record either directly from the device used to obtain the individual's signature on the consent form, or via a third party such as, for example, a front office of the dental clinic.

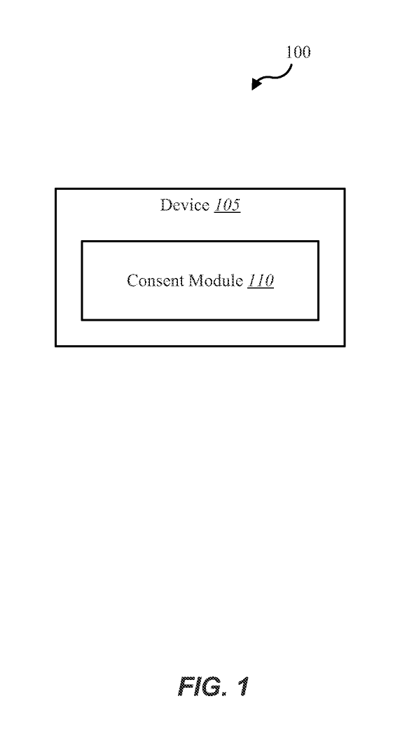

FIG. 1 is a block diagram illustrating one embodiment of an environment 100 in which the present systems and methods may be implemented. In some embodiments, the systems and methods described herein may be performed at least in part on or using a device 105. Environment 100 may also include a consent module 110 as part of or being operable by device 105.

In one embodiment, device 105 and consent module 110 facilitate automatic presentation of an electronic media consent form once a media is generated. The media may be generated by device 105 followed by presentation of a consent form to one or more persons included in the media (e.g., shown in a picture or video) and/or who generate the media (e.g., a voice recording, graphic or text). Additionally, or alternatively, the media may be received by device 105 after being generated from or at a different source or device.

Once the media is received, the consent module 110 presents a consent form for signature by those included in and/or those who generated the media. Once the consent form is signed by the person or persons associated with the media, the signed consent form may be delivered to a storage location. The storage location may be part of device 105. Additionally, or alternatively, the storage location may be remote from device 105. In at least some embodiments, the signed consent form is paired or coupled with a copy of the media to improve accessibility and consistency in identifying the media to which the consent form relates.

As described above, the consent form used by consent module 110 may meet specific regulatory requirements such as, for example, HIPAA requirements. The consent form may have an electronic format that is relatively quickly and easily displayed or presented in another acceptable way to the person signing the media consent. The consent form may be configured for electronic signature and may be receptive of other information related to the person signing the consent form (e.g., full name, mailing address, or other contact information). The electronic consent form may eliminate paper copies of the signed consent form which may otherwise by cumbersome to handle and store, and would otherwise require conversion into an electronic format (e.g., via scanning) in order to be stored electronically.

One example of device 105 is a smartphone that includes a display screen. The smartphone may be used to generate the media (e.g., take a picture, generate a video clip, create an audio recording, create a graphic, or receive a text input). Additionally, or alternatively, the smartphone may be receptive of media generated by another device and transferred to the smartphone in order to obtain consent via a consent form via operation of consent module 110. Consent module 110 may be part of or operated by the smartphone. Once the media is available, the consent module 110 may operate to present a media consent form for signature by one or more individuals associated with the media (e.g., those individuals shown in a picture or video clip, recorded in an audio recording, or who created graphics or written text). The smartphone may have a user interface separated from or integrated into the display screen of the smartphone for use in entering information about the individual signing the consent form and receiving the individual's signature. In some embodiments, the display screen is configured as a touch screen that functions at least in part as a user interface and may be receptive of an individual's electronic signature or other form of consent.

Consent module 110 may operate to couple or pair the media with the signed consent form. The consent form and media may be stored in the memory of the smartphone. Additionally, or alternatively, the media and consent form may be transmitted to a storage location via, for example, a text message, an email, a drop box, or any other data transmission medium. In one example, the media and consent form are transmitted via email to a front office such as a front office of a dental clinic. The email may be received in a specific in-box dedicated to receiving and/or storing the consent forms and/or media. Additionally, or alternatively, the email and/or consent form and media may be stored in more permanent storage such as, for example, a local hard disk drive, a cloud storage database, a back end server, or the like.

The smartphone may also be used to publish the media to a social media platform after the media consent form is signed. Once the consent form is signed, the user of the smartphone may be prompted to select among a variety of social media platforms wherein links or tabs are displayed on the display screen of the smartphone. Some example social media platforms include Facebook, Twitter, Instagram, Google+, LinkedIn, Foursquare, Pinterest and the like. Typically, the media is uploaded to a social media platform separately from the signed media consent form. The signed consent form is stored for potential future later use in the event there is a conflict concerning the individual's consent related to use of the media by the person or entity who generated the media and/or published the media.

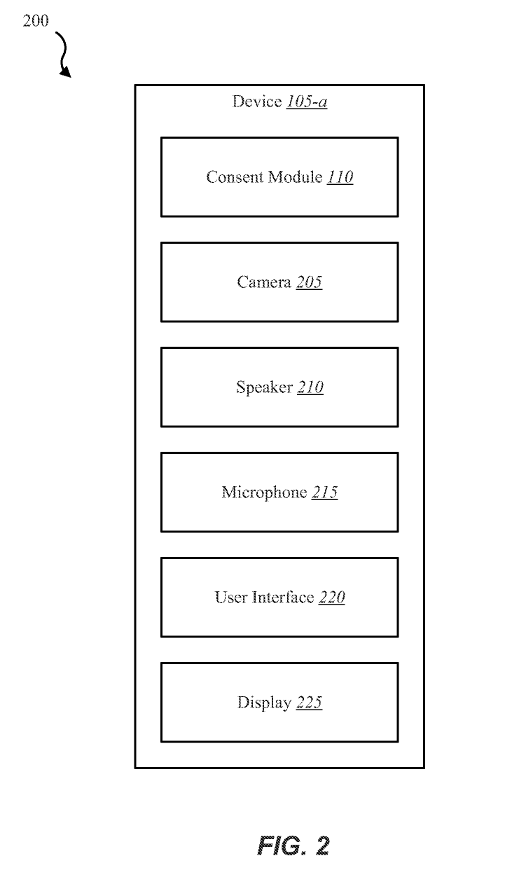

FIG. 2 is a block diagram illustrating one embodiment of an environment 200 in which the present systems and methods may be implemented. Environment 200 may include the same or similar components as discussed above related to environment 100. In some embodiments, the systems and methods described herein may be performed at least in part on or using a device 105-a that includes or operates consent module 110. Device 105-a may also include a camera 205, a speaker 210, a microphone 215, a user interface 220, and a display 225. At least camera 205, speaker 210, and microphone 215 may be operable to generate media. The media may be displayed on display 225. A user of device 105-a may interface with device 105-a via user interface 220. User interface 220 may be integrated into or otherwise include display 225. A user may interface with device 105-a via one or more of the camera 205, speaker 210, and microphone 215. In at least some examples, a media consent form presented to one or more persons associated with the media may be displayed on display 225. The individual for whom media consent is requested may provide the consent in a number of ways including, for example, a video recording via camera 205, a spoken consent provide via microphone 215, or a written consent via other features such as, for example, a key pad or a touch screen separate from or integrated into display 225 or otherwise provided via user interface 220.

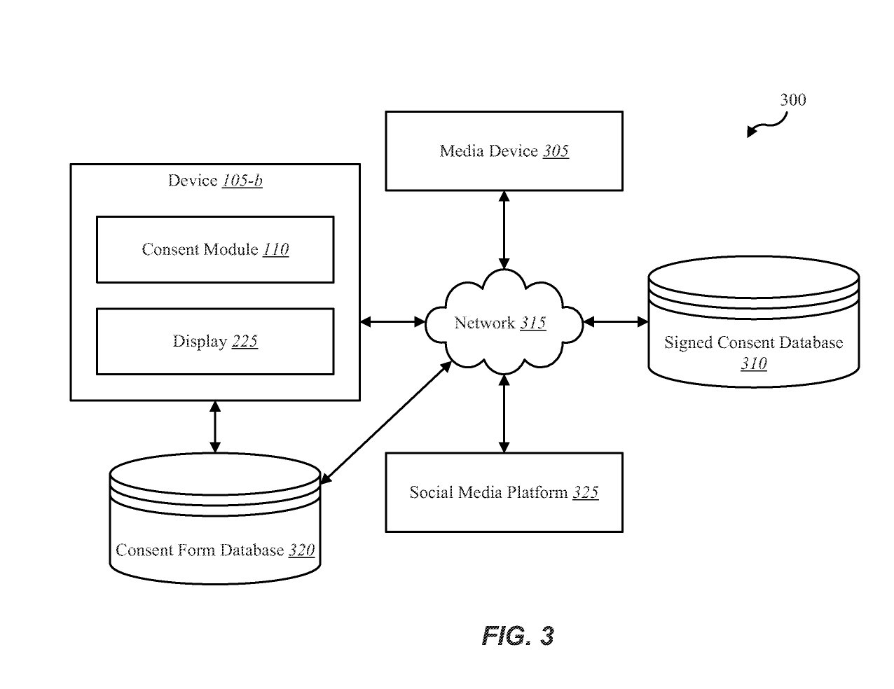

At least some, if not all, of the features of device 105-a shown in FIG. 2 may be included in a smartphone, which makes smartphones particularly advantageous for implementation of the present systems and methods, or at least portions thereof. However, other computing devices may be used as device 105-a. For example, a desktop computer may include some if not all of the components of device 105-a. In other examples, at least some of the components of device 105-a may be provided separate from although in electronic communication with the other features of device 105-a. Some such examples are described below with reference to FIGS. 3-5.

FIG. 3 is a block diagram illustrating one embodiment of an environment 300 in which the present systems and methods may be implemented. Environment 300 may include the same or similar components as discussed above related to environments 100, 200. In some embodiments, the systems and methods described herein may be performed at least in part on or using a device 105-b. Device 105-b may include consent module 110 and display 225. Environment 300 may also include a media device 305, a signed consent database 310, a network 315, a consent form database 320, and a social media platform 325.

The consent module 110 may, in response to media being generated by device 105-b or being received by device 105-b, present a media consent form for signature by those persons associated with the media. The consent form may be presented on display 225. In at least some examples, display 225 may include a touch screen or other user interface (e.g., user interface 220) to receive the person's signature or other legally acceptable form of consent for use of the media. Consent module 110 may reference consent form database 320 as part of selecting the proper consent form for the particular media and/or application of the media at issue. In one example, consent module 110 may generate a list of consent forms available in consent form database 320. A user may select among the available consent forms, and the selected consent form is displayed on display 225. In at least some examples, consent form database 320 is integrated into device 105-b. Alternatively, consent form database 320 is available via communication directly from device 105-b, or indirectly via network 315. In some embodiments, consent module 110 automatically selects among a plurality of consent forms available in consent form database based on criteria associated with the media and/or industry of the person/company that is seeking the media consent.

Media device 305 may be used to generate media in the form of, for example, pictures, video clips, audio recordings, graphics, or written content for which consent is required prior to publishing of the media by someone other than the individual who is shown in and/or created the media. The media generated by media device 305 may be transmitted to device 105-b. Upon receiving the media, consent module 110 may present the media consent form for signature. In one example, media device 305 is a smartphone or other computing device such as, for example, a tablet computer, laptop computer, desktop computer, camera, recording device, or the like. Media device 305 may operate in close proximity to device 105-b. Additionally, or alternatively, media device 305 may be operated remotely from device 105-b, such as, for example, in separate rooms, separate buildings or different geographic areas from each other such as, for example, in different states or countries.

The signed consent form may be transmitted to signed consent database 310. Signed consent database 310 may be accessible via network 315. Signed consent database 310 may store both the signed consent forms as well as the media to which the signed consent form relates. Signed consent database 310 may include data storage capabilities. In some examples, signed consent database 310 is part of device 105-b and may include, for example, memory of device 105-b. Additionally, or alternatively, signed consent database 310 may be a remote database such as, for example, a back end server, cloud storage, a desktop or laptop computer hard drive, or the like.

Once the media consent form is signed, consent module 110 may publish the media to one or more social media platforms 325. The media may be uploaded to the social media platform 325 via network 315. A plurality of different social media platforms 325 may each be used to broadcast the media.

Examples of network 315 include cloud networks, local area networks (LAN), wide area networks (WAN), virtual private networks (VPN), wireless networks (using 802.11, for example), and/or cellular networks (using 3G and/or LTE, for example), etc. In some embodiments, network 315 may include the Internet.

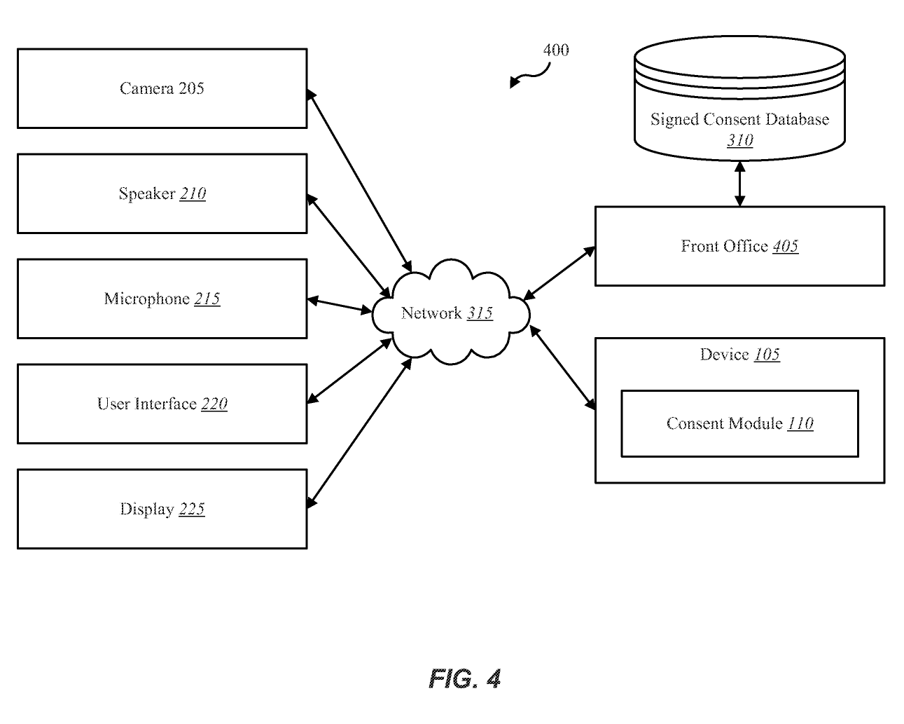

FIG. 4 is a block diagram illustrating one embodiment of an environment 400 in which the present systems and methods may be implemented. Environment 400 may include the same or similar components as discussed above related to environments 100, 200, 300. In some embodiments, the systems and methods described herein may be performed at least in part on or using device 105, which may operate consent module 110. Environment 400 may also include camera 205, speaker 210, microphone 215, user interface 220, and display 225, which may be provided as separate components, or provided in some combination. Environment 400 may also include a front office 405 which communicates with the signed consent database 310. The components of environment 400 may communicate with each other via network 315.

Any one of camera 205, speaker 210 and microphone 215 may be used to generate one or more media. At least some types of media may be reviewable via display 225. A user may select among various media and/or modify/edit the media using user interface 220. The media may be presented on device 105 or otherwise made available for review. Additionally, or alternatively, a notice may be sent to device 105 concerning generation and/or storage of the media on another device. Consent module 110 may present a media consent form (e.g., via display 225) for signature by those associated with the generated media. Consent module 110 may present the media consent form automatically based on various prompts or timing associated with creation, finalization, or transmission of the media.

Once the media consent form is signed, the media consent form may be paired or linked with the media. Whether alone or in combination with the media, the consent form may be transferred to front office 405. In at least one example, front office 405 may include a computerized device associated with an office such as, for example, a dental office, medical office, or the like. Front office 405 may evaluate the media consent form to confirm that it is filled out accurately and completely. The signed media consent may be saved to signed consent database 310. Front office 405 may directly transmit the signed consent form, alone or in combination with the media, to signed consent database 310. Additionally, or alternatively, front office 405 may transmit the signed consent form, alone or in combination with the media, to signed consent database 310 via network 315. Similarly, device 105 and front office 405 may communicate directly without using network 315. Various networks or communication mediums may be used to communicate between the components of environment 400 shown in FIG. 4.

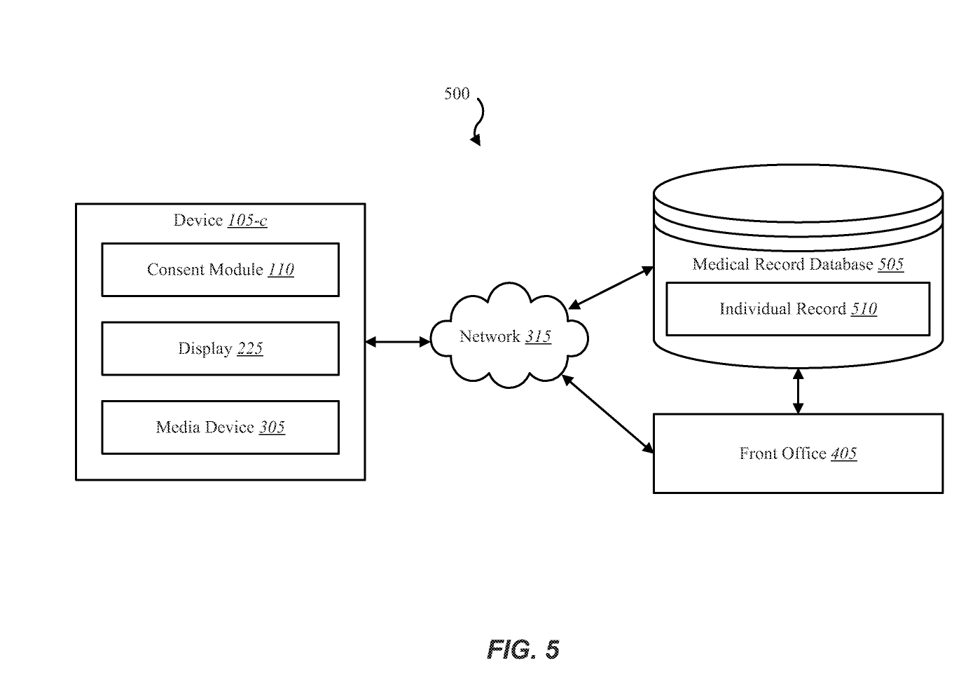

FIG. 5 is a block diagram illustrating one embodiment of an environment 500 in which the present systems and methods may be implemented. Environment 500 may include the same or similar components as discussed above related to environments 100, 200, 300, 400. In some embodiments, the systems and methods described herein may be performed at least in part on or using a device 105-c. Device 105-c includes consent module 110, display 225, and media device 305. Device 105-c may communicate with front office 405 and/or a medical record database 505 via network 315.

Medical record database 505 may include a plurality of individual records 510. The signed media consent form, alone or in combination with the media to which the consent form relates, may be transferred to and stored in or with the individual records 510. The signed media consent forms may be transmitted directly from device 105-c to medical record database 505. Additionally, or alternatively, the signed media consent form may be transferred from device 105-c to front office 405, and from front office 405 to medical record database 505 either directly or via network 315.

Medical record database 505 may store and/or manage medical-related information. Additionally, or alternatively, medical record database 505 may provide storage of data that is not of a medical nature. For example, the data stored by medical record database 505 may be one or more individual records 510 associated with a person, and may include information of a personal or private nature. For example, the individual record 510 may include information such as, for example, social security number, marriage date, names of children, work history, resident history, family members, passwords, photographs, documents, and the like. In other embodiments, the individual record 510 may include data or other information associated with one or more persons that is of a public nature, or information otherwise made available by the person to a selected group or to the public generally.

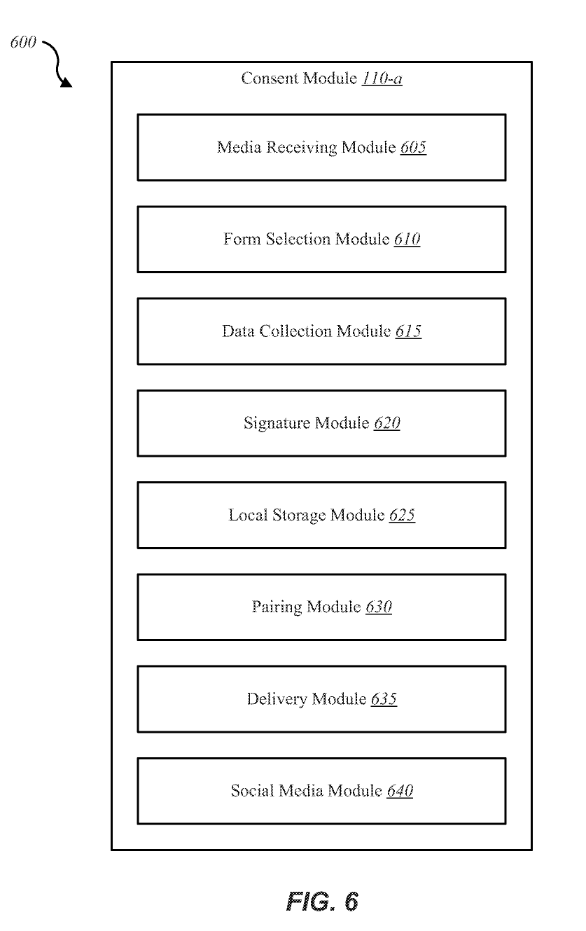

FIG. 6 is block diagram illustrating one example of a consent module 110-a, which may be one example of the consent module 110 shown and described with reference to FIGS. 1-5. Consent module 110-a may include a media receiving module 605, a form selection module 610, a data collection module 615, a signature module 620, a local storage module 625, a pairing module 630, a delivery module 635, and a social media module 640.

Media receiving module 605 may be operable to receive at least one media file, data packet, or the like in the form of, for example, an audio file, a photograph, a video clip, or the like. Media receiving module 605 may identify the type of media, the size of the media, and any special requirements associated with handling, storing or displaying the media. Media receiving module 605 may temporarily store the media while consent module 110-a operates to perform other steps and functions.

Form selection module 610 may automatically select a particular consent form for a particular type of media. In one embodiment, form selection module 610 presents a list of consent forms for a user to select among as part of automatically presenting a consent form to the user. Form selection module 610 may operate based on one or more rules to automatically select a particular consent form for a given media, particular user, industry, or other desired criteria.

Data collection module 615 may operate to receive data from one or more users in association with the media and/or the consent form. For example, data collection module 615 may prompt a user for information such as, for example, full name, mailing address, email address, age, etc., which information may be used to automatically populate the consent form with the required information. Data collection module 615 may be integrated with a user interface to assist in receiving the required information for completing the consent form. Data collection module 615 may collect or prompt the user for other information that is not necessarily required for the consent form including, for example, information for storage of the consent form, delivery of the consent form to the individual and/or person/company who is requesting consent, or the like. Data collection module 615 may automatically tag the consent form with general information such as date, time and location associated with generation of the media and/or signature of the media consent.

Signature module 620 may prompt and/or receive a signature from a person giving the media consent. Signature module 620 may receive a signature in a variety of ways including, for example, prompting the user on a display screen and receiving an electronic signature that is either typed or drawn/written into the consent form (e.g., via a touch sensitive portion of the display screen). The prompt may include a visual, audible or other message. Signature module 620 may populate a consent form with the individual's signature. The signature may be used for other reasons or purposes including, for example, permission to use the media consent for certain purposes, consent to store and/or transmit the media consent and/or media, etc.

Local storage module 625 may maintain a local copy of the media and/or media consent prior to, during, and/or after delivering the consent and/or media for permanent storage. Local storage module 625 may maintain a local copy of the media consent and/or media for a predetermined time period or until a certain action is completed (e.g., delivery of the consent and/or media to a different location for storage). Local storage module 625 may automatically erase temporary and/or local copies of the media consent and/or media based on predetermined criteria or rules.

Pairing module 630 may link or pair together the signed media consent with the media. Pairing module 630 may use identifiers, coding, etc. to create an electronic identifier common to both of the media consent and media as part of linking or pairing. Pairing module 630 may link or pair a single media consent with a plurality of different media. In at least some examples, a single media is linked to a plurality of different media consents when, for example, a plurality of people are included in a single media and consent is required from each person.

Delivery module 635 may operate to deliver the media consent and/or media to a different location such as, for example, a front office, a medical record database, a cloud storage database, a back end server, or the like. Delivery module 635 may deliver the signed media consent and/or media via, for example, a network such as network 315 shown and described with reference to FIGS. 1-5.

Social media module 640 may operate to deliver or submit a copy of the media to one or more social media platforms. In one example, social media module 640 prompts a user to select among one or more social media platforms for posting the media. Social media module 640 may prompt the user to select among the social media platforms after, for example, the required media consent form is signed and/or delivered. Social media module 640 may automatically prompt the user to select among one or more social media platforms. Additionally, or alternatively, social media module 640 may automatically post the media to a particular social media platform based on preset criteria or rules. Social media module 640 may include with the media information collected about the person providing consent including, for example, a name received by data collection module 615.

Consent module 110-a may also operate to identify the number of people in a given media. The number of people in the media may be used as part of, for example, selecting what types and/or number of media consents should be presented to the individuals providing consent.

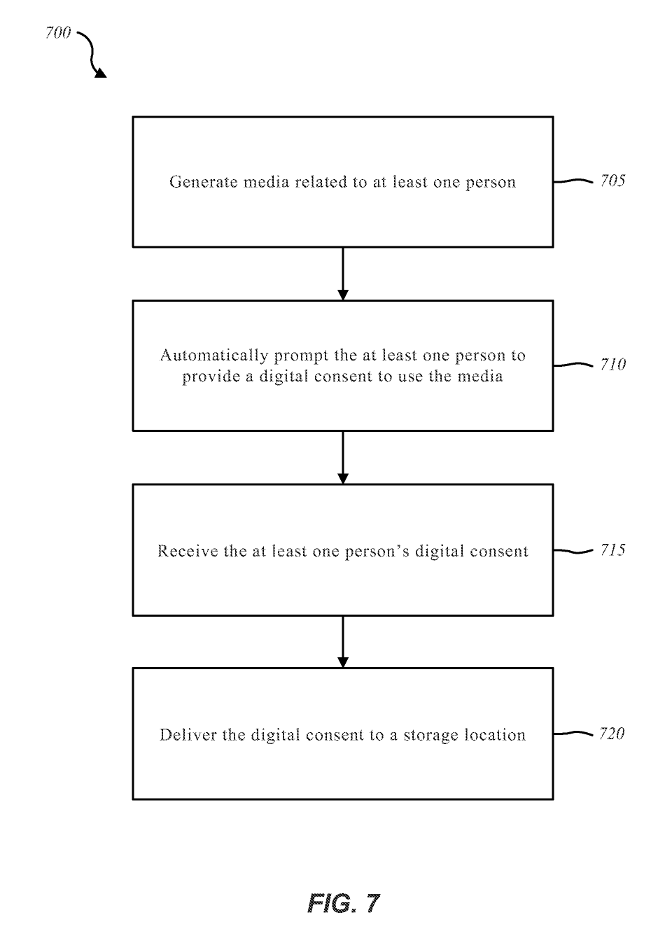

FIG. 7 is a flow diagram illustrating one embodiment of a method 700 for obtaining media consent. In some configurations, the method 700 may be implemented by the consent module 110 shown and described with reference to FIGS. 1-6. In other examples, the method 700 may be performed generally by device 105 shown in FIGS. 1-5, or even more generally by environments 100, 200, 300, 400, 500 shown in FIGS. 1-5.

At block 705, the method 700 includes generating media related to at least one person. Block 710 includes automatically prompting the at least one person to provide a digital consent to use the media. At block 715, method 700 includes receiving the at least one person's digital consent. Block 720 includes delivering the digital consent to a storage location.

The media of method 700 may be at least one of a digital media, a video clip, an audio recording, or any combination thereof. Prompting the at least one person for digital consent may include displaying a Health Insurance Portability and Accountability Act (HIPAA) compliant form to the at last one person. Receiving the at least one person's digital consent may include receiving the at least one person's digital signature. The steps of generating, prompting, receiving and delivering may be connected using a single handheld computing device. Delivering the digital consent may include emailing the digital consent. The method 700 may also include storing the digital consent in a database. Receiving the at last one person's digital consent may include receiving information including at least one of a name and signature of the at least one person (or a parent or guardian of the at least one person in the case of a minor) and entering the information into an electronic consent form. Prompting the at least one person for digital consent may occur automatically after generating the media. Prompting at least one person for digital consent may include prompting each of a plurality of people included in the media for digital consent. The method 700 may include delivering the media with the digital consent to the storage location.

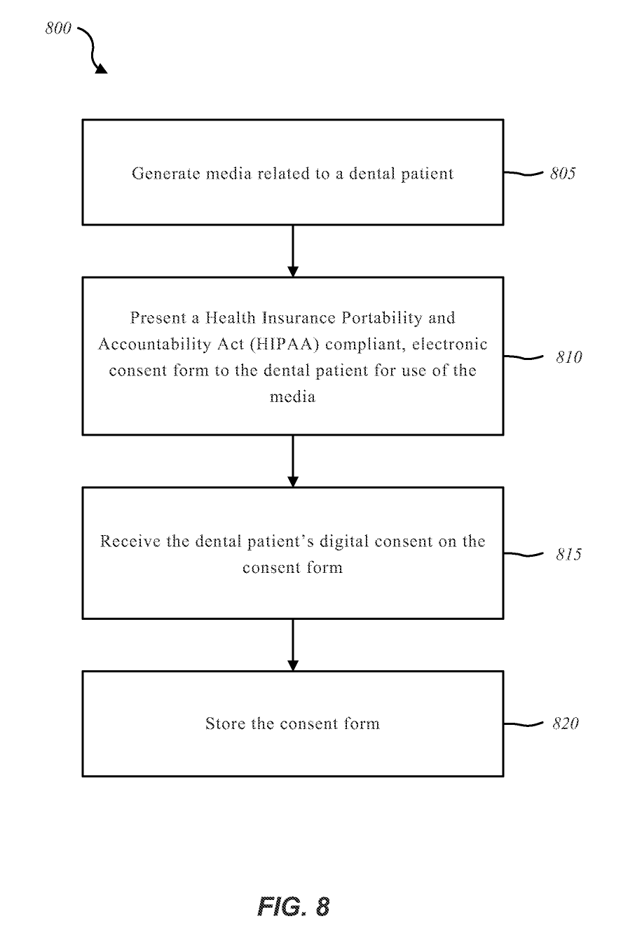

FIG. 8 is a flow diagram illustrating one embodiment of a method 800 for obtaining digital consent to use dental related media. In some configurations, the method 800 may be implemented by the consent module 110 shown and described with reference to FIGS. 1-6. In other examples, the method 800 may be performed generally by device 105 shown in FIGS. 1-5, or even more generally by environments 100, 200, 300, 400, 500 shown in FIGS. 1-5.

At block 805, the method 800 includes generating media related to a dental patient. Block 810 includes presenting a Health Insurance Portability and Accountability Act (HIPAA) compliant, electronic consent form to the dental patient for use of the media. At block 815, method 800 includes receiving the dental patient's digital consent on the consent form. Block 820 includes storing the consent form.

The method 800 may also include delivering the consent form to a remote location. Receiving the dental patient's consent may include receiving a full name and an electronic signature for the patient or a parent or guardian of the patient (in the case of the patient being a minor). The method may be carried out using a handheld computing device. The media may include a digital image of at least some of the dental patient's teeth.

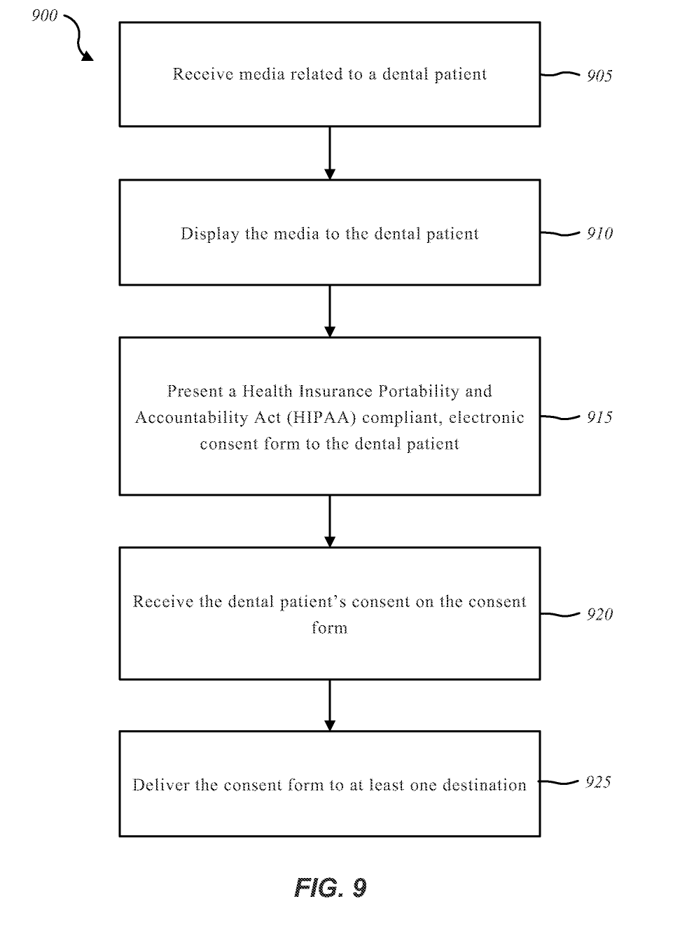

FIG. 9 is a flow diagram illustrating one embodiment of a method 900 for obtaining consent to use dental related media. In some configurations, the method 900 may be implemented by the consent module 110 shown and described with reference to FIGS. 1-6. In other examples, the method 900 may be performed generally be device 105 shown in FIGS. 1-5, or even more generally by environments 100, 200, 300, 400, 500 shown in FIGS. 1-5.

At block 905, the method 900 includes receiving media related to a dental patient. Block 910 includes displaying the media to the dental patient. At block 915, method 900 includes presenting a Health Insurance Portability and Accountability Act (HIPAA) compliant, electronic consent form to the dental patient. Block 920 includes receiving the dental patient's consent on the consent form. At block 925, method 900 includes delivering the consent form to at least one destination.

In some examples, delivering the consent form comprises emailing the consent form, and the at least one destination comprises a dental office. Displaying the media may include displaying the media on a hand-held, mobile computing device. Presenting the consent form may include displaying the consent form concurrently with or after displaying the media.

As mentioned above, one use case example for application of the inventive principles disclosed herein includes a smart phone as the device 105 shown in FIGS. 1-5, and the consent module 110 described with reference to FIGS. 1-6 is operated at least in part by the smart phone. The smart phone includes capability to generate media such as, for example, by taking a picture, recording video, making an audio recording, and/or receiving a written text or graphic. A person, such as a patient at a dental office, may be the originator of the media and/or the person included in the media. Once the media is generated using the smart phone (e.g., whether an IOS, Android, Microsoft, or other product), the consent module may automatically present the media for viewing by the person who is to give consent for use of the media. The consent module may automatically present a media consent on a display of the smart phone for viewing by the individual. The consent module may prompt the user for information such as, for example, the individual's name, address, age, gender, etc. or the name, address, age, gender, etc. of a parent or guardian of the patient which may be needed for completing the media consent form. The consent module may also prompt the user (or the parent or guardian of the user) for an electronic signature (also referred to as a digital signature). The user may input information using a user interface of the smart phone such as a touch screen of the smart phone.

Other capability of the smart phone may be used to receive consent and/or other information from the individual in other ways such as, for example, voice commands, pictures, or the like. Once the media consent is completed, the consent module may operate on the smart phone to deliver the media consent to another location for storage. In one example, the smart phone sends an email with the media consent attached. The email may be delivered to a front office of, for example, a dental office. The smart phone may also send a copy of the media with the media consent. In at least some examples, the media consent is paired or linked to the media prior to or as part of delivering the media consent to another location for storage. The smart phone may also operate to post the media to a social media platform. For example, after the media consent is delivered to another location for storage (e.g., an email is sent), the consent module may operate on the smart phone to present the user with one or more options for posting the media to a social media platform. In one example, a list of social medial platforms is presented and the user may select among them for purposes of posting the media to a social media website.

In other use cases, one or more steps involved in obtaining the media consent form and/or using the media, for example, in a social media setting, may be performed with different devices. In one embodiment, the media is generated using one device (e.g., a digital camera), and the media is delivered to another device that operates at least portions of the consent module described herein. The consent module presents a media consent for signature by the person who generates and/or is included in the media. The media consent form may be presented using a separate device from the device that generates the media and/or the device that receives a copy of the media and provides instructions for presenting the consent form for signature. Any one of the devices in this process may also be used to receive other information or data such as, for example, the individual's address, name, age, gender, etc. (or the address, name, age, gender, etc. of a parent or guardian of the individual), in addition to or separate from obtaining a digital signature for the media consent. The signed media consent may be stored locally or may be sent to a different location for storage. The media may be linked or paired to the media consent prior to or as part of storing and/or delivering the signed media consent for storage.

The media consent that is presented for signature may be used for obtaining consent from two or more different people associated with the media. Additionally, or alternatively, separate media consent forms may be presented for each person associated with the media. The consent form presented for signature may be customized for a particular application or use of the media. For example, the media consent form may be a Health Insurance Portability and Accountability Act (HIPAA) compliant electronic consent form that is customized for use in the dental industry. In at least some examples, the consent form is customized for use in a particular type of social media or other forum for the benefit of a third party. The media consent may include an assignment of rights, and may include language specific to persons of a particular age, gender, citizenship, employment status, or the like.

The media for which media consent is solicited may include information specific to a particular industry or application. For example, in the dental industry, the media may be focused more specifically on one or more of a person's teeth or other facial feature. In a medical setting, particularly a dermatologist setting, the media may focus on a skin condition. In an ophthalmology setting, the media may focus on a user's eyes or appearance of the person's head with a pair of glasses, contacts or other eyewear. In a sports apparel setting, the media may include a person's appearance when wearing a certain apparel such as a hat, shirt, shorts, pants, shoes, gloves, outerwear, or the like. In a musical setting, the media may relate to a person's voice, an instrument recording, or the like. In a journalism setting, the media may be focused on a person's written materials or other artistic expression. Regardless of the application, industry, or focus of the media, the systems and methods disclosed herein may provide for obtaining real-time, electronic media consent that occurs at or near the time of generation of the media, provide for storage of the media consent and media together or separately, and/or facilitate broadcasting of the media to a public setting such as, for example, a social media platform. The systems and methods disclosed herein may substantially eliminate the need for hard copies or paper copies of media consent and the challenges associated with storing such hard copies and/or creating an electronic copy (e.g., via a digital scan).

While a smart phone is described herein as one particularly effective way of implementing the systems and methods disclosed herein, many other types of electronic devices may be used to carry out the inventive principles disclosed herein. In at least one example, the consent module is embodied in one or more apps that may be operated on any of a variety of different computing devices. Such apps may be operated on, for example, a tablet computing device, laptop computer, or other mobile computing device. The app may also operate on a stationary computing device such as, for example, a desktop computer or server. Certain aspects of the consent module may be operated on a plurality of different computing devices depending on when and how the various functions of the systems and methods disclosed herein are carried out. The various devices may be arranged in electronic communication via, for example, a network, such as a wired or wireless network. The capabilities of communicating via a network make it possible to seamlessly connect a variety of devices that may be located in separate physical locations, wherein each particular location is advantageous for a certain step in the process of, for example, generating media, obtaining signature on a media consent form, storing the signed media consent, and broadcasting the media for use in public settings (e.g., via a social media platform).

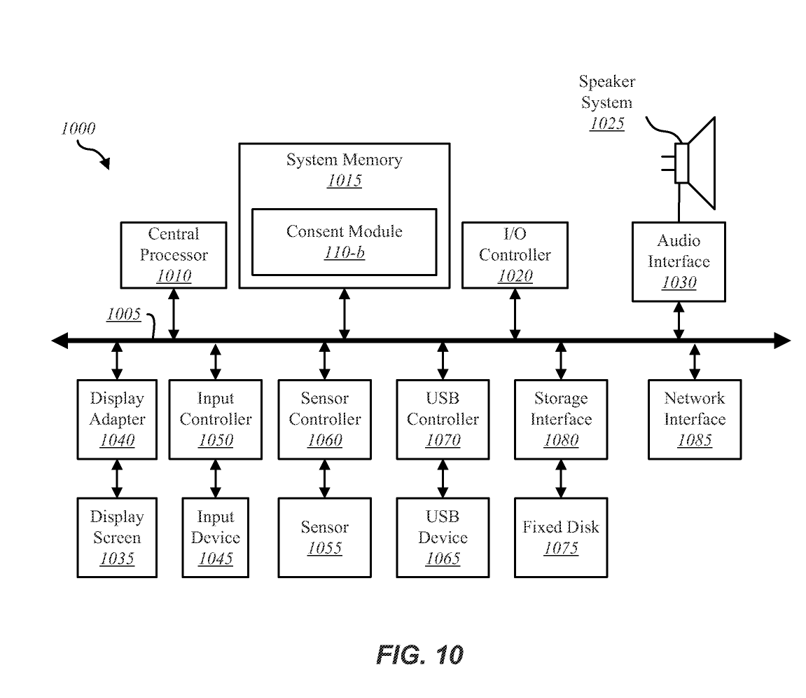

FIG. 10 depicts a block diagram of a controller 1000 suitable for implementing the present systems and methods. In one configuration, controller 1000 includes a bus 1005 which interconnects major subsystems of controller 1000, such as a central processor 1010, a system memory 1015 (typically RAM, but which may also include ROM, flash RAM, or the like), an input/output controller 1020, an external audio device, such as a speaker system 1025 via an audio output interface 1030, an external device, such as a display screen 1035 via display adapter 1040, an input device 1045 (e.g., remote control device interfaced with an input controller 1050), multiple USB devices 1065 (interfaced with a USB controller 1070), and a storage interface 1080. Also included are at least one sensor 1055 connected to bus 1005 through a sensor controller 1060 and a network interface 1085 (coupled directly to bus 1005).

Bus 1005 allows data communication between central processor 1010 and system memory 1015, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the consent module 110-b to implement the present systems and methods may be stored within the system memory 1015. Applications resident with controller 1000 are generally stored on and accessed via a non-transitory computer readable medium, such as a hard disk drive (e.g., fixed disk 1075) or other storage medium. Additionally, applications can be in the form of electronic signals modulated in accordance with the application and data communication technology when accessed via network interface 1085.

Storage interface 1080, as with the other storage interfaces of controller 1000, can connect to a standard computer readable medium for storage and/or retrieval of information, such as a fixed disk drive 1075. Fixed disk drive 1075 may be a part of controller 1000 or may be separate and accessed through other interface systems. Network interface 1085 may provide a direct connection to a remote server via a direct network link to the Internet via a POP (point of presence). Network interface 1085 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to controller 1000 wirelessly via network interface 1085.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 10 need not be present to practice the present systems and methods. The devices and subsystems can be interconnected in different ways from that shown in FIG. 10. The aspect of some operations of a system such as that shown in FIG. 10 are readily known in the art and are not discussed in detail in this application. Code to implement the present disclosure can be stored in a non-transitory computer-readable medium such as one or more of system memory 1015 or fixed disk 1075. The operating system provided on controller 1000 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method for obtaining digital consent to use dental related media, comprising:
generating dental related media related to at least one person in a dental office setting using a media generating device, the media generating device including a camera, the media including at least one of a digital image of the at least one person, or a video clip of the at least one person, or an audio recording of the at least one person, or any combination thereof;
automatically displaying on a display of the media generating device immediately after generating the media a consent form for the at least one person to provide a digital consent to use the media;
receiving the at least one person's digital consent on the consent form, wherein the media is released for use only upon receiving the digital consent;
delivering the consent form with the digital consent to a storage location;
presenting at least one social media site option for posting the media;
receiving at least one social media site selection; and
delivering the media to the at least one selected social media site;
wherein a content of the media is unrelated to providing consent to use the media.

2. (canceled)

3. The method of claim 1, wherein the consent form is a Health Insurance Portability and Accountability Act (HIPAA) compliant form.

4. The method of claim 1, wherein receiving the at least one person's digital consent comprises:
receiving the at least one person's digital signature or a signature of a parent or guardian of the at least one person.

5. The method of claim 1, wherein the media generating device is a handheld computing device.

6. The method of claim 1, wherein delivering the consent form with the digital consent comprises:
emailing the consent form with the digital consent.

7. The method of claim 1, further comprising:
storing the consent form with the digital consent in a database.

8. The method of claim 1, wherein receiving the at least one person's digital consent comprises:
receiving information including at least one of a name or address of the at least one person; and
entering the information into the consent form.

9. The method of claim 1, wherein prompting the at least one person for digital consent occurs automatically after generating the media.

10. The method of claim 1, further comprising:
displaying the media on the media generating device.

11. The method of claim 1, further comprising:
delivering the media with the consent form and digital consent to the storage location.

12. An apparatus for obtaining digital consent to use dental related media, comprising:
a processor;
a memory in electronic communication with the processor;
a camera; and
instructions stored in the memory, the instructions being executable by the processor to:
generate dental related media related to a dental patient in a dental office setting using the camera, the media including at least one of a digital image of the at least one person, or a video clip of the at least one person, or an audio recording of the at least one person, or any combination thereof;
automatically displaying on a display of the media generating device immediately after generating the media a Health Insurance Portability and Accountability Act (HIPAA) compliant, electronic consent form to the dental patient for use of the media;
receive the dental patient's digital consent on the consent form, wherein the media is released for use only upon receiving the digital consent;
store the consent form; and
deliver the media to a social media site;
wherein a content of the media is unrelated to providing consent to use the media.

13. The apparatus of claim 12, wherein the instructions are executable by the processor to:
deliver the consent form to a remote location.

14. The apparatus of claim 13, wherein receiving the dental patient's digital consent comprises:
receiving at least one of a full name and an electronic signature of the dental patient and a full name and signature of a parent or guardian of the patient.

15. The apparatus of claim 12, wherein the apparatus is a handheld computing device.

16. The apparatus of claim 12, wherein the media includes a digital image of at least some of the dental patient's teeth.

17. A computer-program product for obtaining consent to use dental related media, the computer-program product comprising a non-transitory computer-readable medium storing instructions executable by a processor to:
generate with a camera of a handheld device dental related media related to a dental patient in a dental office setting;
display the media to the dental patient on a display of the device;
automatically displaying on the display a Health Insurance Portability and Accountability Act (HIPAA) compliant, electronic consent form to the dental patient on the handheld device immediately after displaying the media to the dental patient;
receive the dental patient's consent on the consent form using the handheld device, wherein the media is released for use only upon receiving the consent; and
deliver the consent form to at least one destination;
wherein a content of the media is unrelated to providing consent to use the media.

18. The computer-program product of claim 17, wherein delivering the consent form comprises emailing the consent form, and the at least one destination comprises a dental office.

19. The computer-program product of claim 17, wherein the device is a handheld, mobile computing device.

20. The computer-program product of claim 17, wherein presenting the consent form comprises:
displaying the consent form after displaying the media.
